(19) United States
(12) Patent Application Publication
(10) Pub. No.: US 2024/0333154 A1
(43) Pub. Date: Oct. 3, 2024

(54) DETECTION SYSTEM FOR SWITCHING ELEMENT SATURATION

(71) Applicant: Texas Instruments Incorporated, Dallas, TX (US)

(72) Inventor: Tawen Mei, Sunnyvale, CA (US)

(21) Appl. No.: 18/193,536

(22) Filed: Mar. 30, 2023

(51) Int. Cl. H02M 3/158; H02M 1/00

(52) U.S. Cl. CPC H02M 3/158; H02M 1/0009

(57) ABSTRACT

A saturation detection system determines when a first transistor device enters or is in saturation. The system includes a comparator block coupled between an input voltage rail and a bootstrapped voltage rail, and the first transistor is coupled between the input voltage rail and a switching node terminal. A second transistor device is coupled to an output of the comparator block and is used to signal when the first transistor device enters saturation. One or more transistor devices within the comparator block switch off when the voltage across the drain and source terminals of the first transistor device becomes higher than a saturation threshold. When this happens, the output of the second transistor device may be toggled, which can be detected using sensing logic. The saturation detection system may have particular usefulness in voltage regulators that use switching element to sense inductor current, such as buck and/or boost converters.

### TECHNICAL FIELD

This description relates to transistor circuits, and more particularly, to detecting the onset of switching element saturation in a power converter.

### BACKGROUND

Most modern power converters utilize a metal oxide semiconductor field effect transistor (MOSFET) as a power switch. Current sensing may be performed by the converter as long as the MOSFET switch operates in the linear region (also referred to as the triode region) in which the drain current is linearly proportional to the voltage drop between the source and drain terminals of the MOSFET. However, if the MOSFET enters saturation, then the voltage drop across the source and drain terminals can no longer be relied upon to indicate the drain current. In saturation, the source-to-drain voltage can continue to increase while the drain current remains mostly constant. A MOSFET may unexpectedly enter saturation for a variety of reasons, such as while transitioning between on and off states, increased temperature, high currents, or weak process corners in the fabrication of the MOSFET.

### SUMMARY

A saturation detection system is described that includes a circuit coupled to a given transistor device and configured to detect when the transistor device transitions from a linear operating mode to a saturation operating mode. A logic output may be generated by the saturation detection system at the onset of saturation, providing relatively quick and accurate feedback regarding the operating state of the transistor device. The system may be used, for example, to detect the operating region of the switching element in a power converter.

According to an embodiment, an integrated circuit includes a first transistor device coupled between an input voltage terminal and a first voltage terminal, a comparator circuit coupled between a second voltage terminal and the input voltage terminal and having a comparator circuit output, and a second transistor device coupled to the second voltage terminal and having a control terminal coupled to the comparator circuit output. The comparator circuit is configured to turn off the second transistor device responsive to the first transistor device entering a saturation operating mode.

According to another embodiment, a voltage regulator includes an input voltage rail, a bootstrapped voltage rail, and a saturation sensing circuit. The saturation sensing circuit includes a comparator block and a field effect transistor (FET). The comparator block is coupled between the bootstrapped voltage rail and the input voltage rail and has an output. The FET has a gate coupled to the output of the comparator block, and a current terminal coupled to the bootstrapped voltage rail. The comparator block is configured to turn off the FET responsive to a high-side switching element being in a saturation operating mode.

According to another embodiment, an integrated circuit includes first, second, third, and fourth field effect transistor (FET) devices. The first FET device is coupled between an input voltage rail and a first voltage terminal. The second FET device has a drain terminal, a source terminal, and a gate terminal, the gate terminal coupled to a second voltage terminal. The third FET device has a drain terminal coupled to the input voltage rail, a source terminal coupled to the source terminal of the second FET device, and a gate terminal coupled to the second voltage terminal. The fourth FET device has a gate terminal coupled to the drain terminal of the second FET device, and a source terminal coupled to the second voltage terminal.

According to another embodiment, a saturation detection circuit includes first, second, and third field effect transistor (FET) devices. The first FET device has a drain terminal, a source terminal, and a gate terminal, the gate terminal coupled to a voltage terminal. The second FET device has a drain terminal coupled to an input voltage rail, a source terminal coupled to the source terminal of the first FET device, and a gate terminal coupled to the voltage terminal. The third FET device has a gate terminal coupled to the drain terminal of the first FET device and a source terminal coupled to the voltage terminal.

### BRIEF DESCRIPTION OF THE DRAWINGS

FIG. 1 is a block diagram of a voltage regulator, in an example.

FIG. 2 is a block diagram showing a part of a saturation detection system relative to a MOSFET of the voltage regulator, in an example.

FIG. 3 is a schematic diagram of the saturation detection system, in an example.

FIG. 4 is a schematic diagram of the saturation detection system and at least part of the voltage regulator, in an example.

FIG. 5 provides a timing diagram for the output of the saturation detection system based on the operation mode of the MOSFET, in an example.

### DETAILED DESCRIPTION

A saturation detection system is described. In an example, the system is configured to determine when a first transistor device (e.g., switching element such as MOSFET or other transistor device) enters saturation and provide a logic output indicating the same. In one such example, the saturation detection system includes a comparator block coupled between an input voltage rail and a bootstrapped voltage rail, wherein the gate of the first transistor device (e.g., MOSFET) may be coupled, for example, to the output of a driver that has its input coupled to a pulse width modulation (PWM) controller output, as sometimes done in the context of a power converter. A second transistor device is coupled to an output of the comparator block and is used to sense or otherwise signal when the first transistor device enters saturation. According to some such examples, one or more MOSFET devices within the comparator block will switch off when the voltage across the drain and source terminals of the first transistor device becomes higher than a given threshold (e.g., the first transistor device enters saturation). When this happens, the comparator turns off the second transistor device, such that the output of the second transistor device may be toggled to a logic LOW level, which can be detected using any suitable sensing logic and beneficially used.

Detection of saturation onset is helpful in a number of applications. For example, in the context of a buck switching converter, the drain-to-source resistance (Rds_on) of the high-side switching element can be used to provide a current sense, which in turn is used to control the converter. However, if that high-side switching element is in saturation, then the sense current is not accurate, which in turn can lead to undesired results (e.g., false over-current faults or premature shut-off of the high-side switching element). Thus, the techniques described herein can be used to enable operation of converters over wider temperature ranges (e.g., saturation may occur at higher temperatures), and may further reduce the cost of converters by allowing operation in the saturation region. The saturation detection system may be used within any integrated circuit having a MOSFET or other transistor device that transitions from linear operation to saturation operation, and may find particular usefulness in voltage regulators that use switching elements to sense current, such as buck switching converters or boost converters.

### General Overview

As described above, a number of non-trivial issues are associated with MOSFET switches. For example, many high power voltage regulators such as DC-DC buck switching converters use a high-side power FET as a switch operating in the linear region in which the drain current of the power FET is linearly proportional to the voltage drop across the drain and source terminals of the power FET. However, if the power FET enters saturation, the voltage can continue to increase across the drain and source terminals with negligible increase to the drain current. Such a situation can damage the power FET, or otherwise cause unintended consequences if the power FET is also being used as a sense element. Some DC-DC switching converters include over-current protection circuits that compare a given voltage drop at or near the power FET to an arbitrary threshold, but such approaches do not accurately determine the onset of saturation and can be unreliable if the power FET behaves in an unexpected way.

Thus, in accordance with some embodiments of the present disclosure, a saturation detection system is provided that may be integrated with a circuit to detect when one or more transistor devices of the circuit transition from a linear operating region to a saturation operating region. In an example, the saturation detection system itself includes an arrangement of FET devices to provide a logic output that toggles in response to a given FET entering saturation. The saturation detection system may be implemented on the same chip as the one or more FETs being tested, or may be provided on a separate chip or within a separate chip package. In some embodiments, the saturation detection system is used within a DC-DC buck switching converter to detect when a high-side power FET of the converter enters saturation, although other power converters as well as other applications may benefit as well.

According to some embodiments, the saturation detection system includes a comparator circuit coupled between an input voltage rail and a bootstrapped voltage rail. The bootstrapped voltage rail may also be coupled to the positive supply rail of a driver (e.g., high-side driver), which in turn has its output coupled to a gate of a FET to be tested (e.g., high-side switching element), while the input voltage rail is coupled to a drain terminal of the FET to be tested. The comparator circuit may include one or more FET devices that are active based on the VDS voltage (voltage across the drain and source terminals) of the FET to be tested. When the VDS voltage raises above a given threshold (e.g., the FET enters saturation) the one or more FET devices of the comparator circuit shut off, which in turn affects the operation of a sensing FET at the output of the comparator circuit. The output of the sensing FET can be detected using any suitable logic circuitry, and the toggling of this output from logic HIGH to logic LOW (or vice-versa) aligns with the moment that the tested FET enters saturation.

Numerous other variations will be apparent based on the embodiments described herein.

### Electronic Device or System

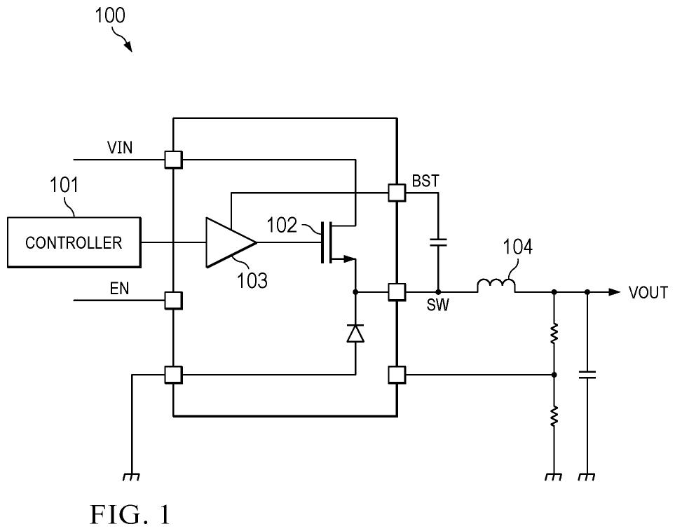

FIG. 1 illustrates at least a portion of an example electronic device or system 100. In some cases, electronic device or system 100 is implemented as a system-on-chip, or a chip set populated on a printed circuit board (PCB) which may in turn be populated into a chassis of a multi-chassis system or an otherwise higher-level system, although any number of implementations can be used. Electronic device or system 100 may be part of a switching regulator, such as a DC-DC buck switching converter.

According to some embodiments, electronic device or system 100 includes a high-side switching element 102 and an inductor 104 for voltage down-conversion. High-side switching element 102 may be an n-channel or p-channel MOSFET. According to some embodiments, the source and drain terminals of switching element 102 may be coupled between an input voltage rail VIN and a voltage terminal SW, which also acts as an input to inductor 104. As shown in this example, the gate of switching element 102 may be coupled to the output of a driver circuit 103, which has its positive supply rail coupled to a bootstrapped voltage rail BST. According to some embodiments, a controller 101 provides a control signal (e.g., PWM control signal) to the input of driver 103, which in turn drives switching element 102 to provide a regulated output voltage VOUT. Controller 101 may also receive various inputs (e.g., feedback voltage FB representative of VOUT, and switching node voltage SW) to facilitate control. The bootstrapped voltage rail BST may have a higher potential compared to the input voltage rail VIN. In some cases, inductor 104 may be, for example, part of a transformer, or any other suitable energy storage element.

During operation, switching element 102 ideally remains within the linear operation region (e.g., the voltage across the source and drain terminals of switching element 102 is less than a saturation threshold voltage). When operating in this mode, switching element 102 can accurately control (and sense) the current through inductor 104 based on the voltage drop across its source and drain terminals. However, if the voltage across the source and drain terminals of switching element 102 becomes too high, switching element 102 enters saturation and the voltage difference no longer accurately indicates the amount of current. Such a situation can cause switching element 102 to become damaged as the voltage continues to rise with little to no discernable rise in the current. Also, if switching element 102 is also being used to sense current through inductor 104, then that sense current may no longer be accurate. Accordingly, it can be beneficial to accurately determine when switching element 102 transitions from the linear operating mode to the saturation operating mode.

### Saturation Detection Circuit Design

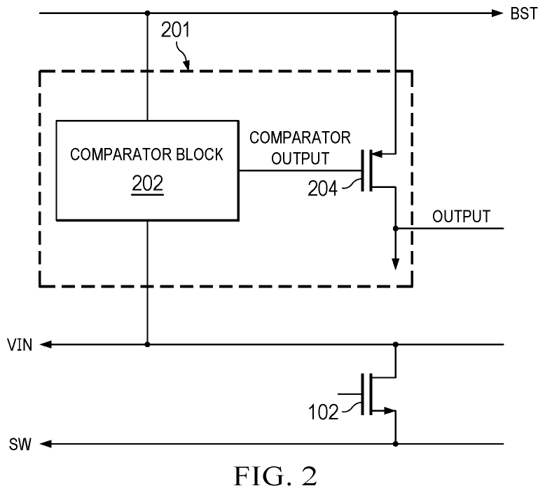

FIG. 2 illustrates a diagram of a saturation detection circuit 201 coupled to switching element 102, according to an embodiment. Saturation detection circuit 201 includes a comparator block 202 coupled between the input voltage rail VIN and the bootstrapped voltage rail BST. According to some embodiments, comparator block 202 includes any number of FET devices whose operation is dependent upon the voltage drop across the source and drain terminals of switching element 102. This bootstrapped voltage BST may also provide the positive supply rail of a driver that has its output coupled to the gate of switching element 102, as described above with respect to FIG. 1.

The output of comparator block 202 is coupled to a gate of a sensing FET 204, according to some embodiments. Sensing FET 204 may be a p-channel FET that switches off in response to a high enough voltage on its gate from the comparator output. According to some embodiments, a source terminal of sensing FET 204 is coupled to the bootstrapped voltage rail BST. The output of saturation detection circuit 201 may be coupled to a drain terminal of switching FET 204. The saturation detection circuit output may toggle from a logic HIGH (e.g., having the BST voltage) to a logic LOW (e.g., ground or whatever baseline voltage is used) in response to switching FET 204 being turned off. As will be discussed in more detail herein, switching FET 204 switches off in response to switching element 102 entering saturation.

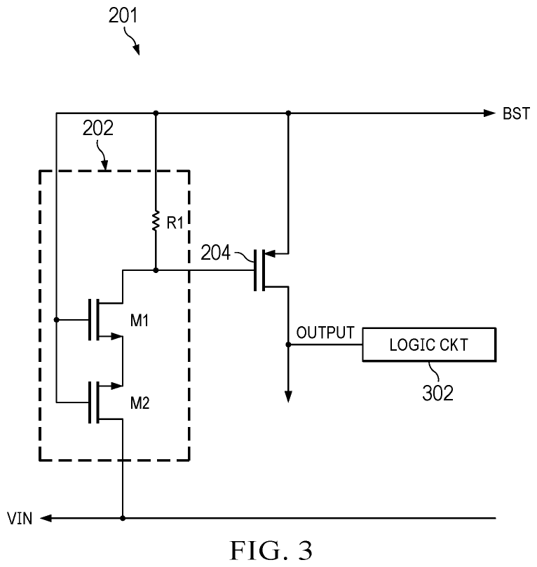

FIG. 3 illustrates a more detailed schematic of saturation detection circuit 201, according to some embodiments. Comparator block 202 may include a first FET M1, a second FET M2, and a resistor R1. In some embodiments, resistor R1 is replaced with a biased-on FET (such as a biased p-channel FET) or a current source. Both FETs M1 and M2 have their gates coupled to bootstrapped voltage rail BST and their source terminals coupled together, according to some embodiments. A drain terminal of FET M2 maybe coupled to input voltage rail VIN while a drain terminal of FET M1 may be coupled to the gate of sensing FET 204 and to bootstrapped voltage rail BST via resistor R1. According to some embodiments, FET M2 is provided to protect FET M1 from situations where BST is brought to a lower voltage than VIN, as this might cause an unsafe reverse bias across the gate and source of M1. In some examples, FET M2 is not present within comparator block 202 in situations where VIN is low enough (e.g., less than 5 V) so as not to cause a damaging reverse-bias across the gate and source terminals of FET M1.

According to some embodiments, FET M1 is a laterally diffused MOS device. A laterally diffused MOS may be used to reduce the drain capacitance to the substrate and thus provide higher switching speeds. Laterally diffused MOS devices may also have a lower ON resistance between the source and drain terminals compared to a non-laterally diffused MOS device. In some embodiments, sensing FET 204 and/or FET M2 is also a laterally diffused MOS device. According to some embodiments, at least one of M1 or M2 is arranged to have a similar voltage drop across its gate and source terminals to the voltage drop across the gate and source terminals of switching element 102 (VGS). In such cases, the other FET of M1 or M2 may be arranged to have a lower voltage drop across its gate and source terminals compared to VGS.

The ON/OFF state of FETs M1 and M2 determine the ON/OFF state of sensing FET 204, according to some embodiments. When FETs M1 and M2 receive a high enough voltage difference between their gates and source terminals, the gate of sensing FET 204 receives roughly the voltage of VIN, which is low enough to bias the p-channel sensing FET 204 on and provide a logic HIGH output. When the voltage drop across the gates and source terminals of FETs M1 and M2 drops below a threshold value, FETs M1 and M2 turn off and the gate of sensing FET 204 receives roughly the voltage of BST, which is high enough to turn off the p-channel sensing FET 204 and provide a logic LOW output.

The output of saturation detection circuit 201 may be received by a logic circuit that provides some function in response to the output changing from a logic HIGH to a logic LOW (or any other state to indicate that switching element 102 is in saturation). In some examples, logic circuit 302 may be configured to turn off switching element 102 to protect it from damage, or to change one or more circuit parameters or potentials to try to bring the operating state of switching element 102 back to the linear regime. In some examples, logic circuit 302 masks, reroutes, or otherwise blocks the output of saturation detection circuit 201 during the initial startup of switching element 102 (as switching element 102 may start in the saturation region). In some examples, logic circuit 302 may produce a warning or alert to a user that the circuit is not functioning properly. The warning or alert may be in the form of a light, sound, vibration, error code, or any combination thereof.

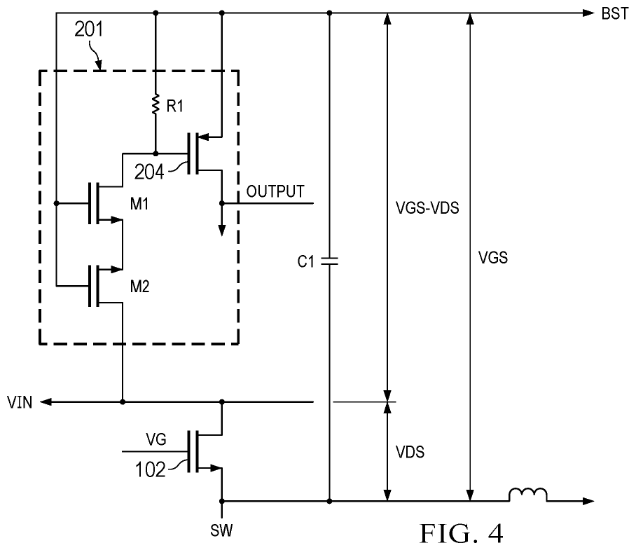

FIG. 4 illustrates the implementation of saturation detection circuit 201 within the broader context of a voltage regulator having the switching element 102, according to some embodiments. A capacitor C1 may be coupled between the bootstrapped voltage rail BST and a lower voltage terminal SW coupled to the source terminal of switching element 102. During operation of the voltage regulator, the lower voltage terminal SW has a lower voltage compared to input voltage rail VIN, which in turn has a lower voltage compared to the bootstrapped voltage rail BST. The input voltage rail VIN may have a voltage between about 10 V and about 800 V depending on the application. In some examples, the input voltage rail VIN is 12 V supplied by a standard car battery.

Sensing FET 204 may be used to detect the onset of saturation for switching element 102. According to some embodiments, FETs M1 and M2 are designed to match or closely resemble the parameters of switching element 102 such that the threshold voltages of M1, M2, and switching element 102 are substantially the same (e.g., within 0.05 V). In some embodiments, switching element 102 is also a laterally diffused MOS device. The voltage across the source and drain terminals of switching element 102 is VDS and the voltage difference between the gate and source terminals (VGS) of switching element 102 is VG−SW. Since VG has the same potential as BST, VGS=BST−SW. Since VIN−SW=VDS, these equations can be combined to show that BST−VIN=VGS−VDS. As noted above, switching element 102 enters saturation when VDS rises above a given threshold. The saturation threshold is roughly equal to VGS−V_{T}, where V_{T} is the threshold voltage of switching element 102.

Because the gates of FETs M1 and M2 are coupled to BST, and the voltage drop across the gates and source terminals of M1 and M2 is equivalent to BST−VIN=VGS−VDS, the change in VDS across switching element 102 can directly affect the ON/OFF state of FETs M1 and M2. According to some embodiments, when VDS rises above the saturation threshold (e.g., switching element 102 enters saturation), the voltage drop across the gates and source terminals of FETs M1 and M2 drops to V_{T} (or below V_{T}) and FETs M1 and M2 turn off. Switching FET M1 from ON to OFF toggles the state of sensing FET 204 from ON to OFF as discussed above, and the output of saturation detection circuit 201 changes accordingly from a logic HIGH to a logic LOW at the same time that switching element 102 enters saturation.

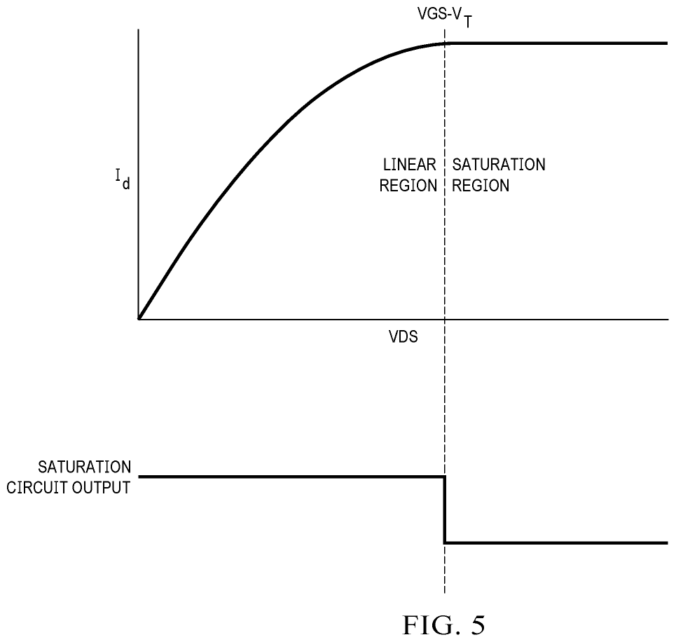

FIG. 5 shows a graph that roughly provides an example drain current through switching element 102 vs applied voltage across the drain and source terminals of switching element 102. When VDS is below a saturation voltage (VGS-V_{T}), the current I_{d} rises roughly linearly with the increase in VDS. However, when VDS rises above the saturation voltage, the current I_{d} levels off and no longer rises proportionally to the increase in VDS. The output of the saturation detection circuit switches from a logic HIGH during the linear operation region of switching element 102 to a logic LOW during the saturation operation region of switching element 102. It should be noted that the saturation circuit output may also toggle from a logic HIGH to a logic LOW upon entering saturation depending on the type of sensing FET used (n-channel vs. p-channel).

### Further Example Embodiments

The following examples pertain to further embodiments, from which numerous permutations and configurations will be apparent.

Example 1 is an integrated circuit that includes a first transistor device coupled between an input voltage terminal and a first voltage terminal, a comparator circuit coupled between a second voltage terminal and the input voltage terminal and having a comparator circuit output, and a second transistor device coupled to the second voltage terminal and having a control terminal coupled to the comparator circuit output. The second transistor device is configured to turn off responsive to the first transistor device entering a saturation operating mode.

Example 2 includes the integrated circuit of Example 1, wherein, in operation, the first voltage terminal has a lower voltage than the input voltage terminal.

Example 3 includes the integrated circuit of Example 1 or 2, wherein, in operation, the second voltage terminal has a higher voltage than the input voltage terminal.

Example 4 includes the integrated circuit of any one of Examples 1-3, further comprising a capacitor coupled between the first voltage terminal and the second voltage terminal.

Example 5 includes the integrated circuit of any one of Examples 1-4, wherein the comparator circuit further comprises a third transistor device and a fourth transistor device.

Example 6 includes the integrated circuit of Example 5, wherein the third transistor device and the fourth transistor device are n-channel devices.

Example 7 includes the integrated circuit of Example 5 or 6, wherein the comparator circuit further comprises a resistor coupled between a terminal of the third transistor device and the second voltage terminal.

Example 8 includes the integrated circuit of Example 7, wherein the terminal of the third transistor device is coupled to the control terminal of the second transistor device.

Example 9 includes the integrated circuit of Example 7 or 8, wherein the fourth transistor device is coupled between the input voltage terminal and the third transistor device.

Example 10 includes the integrated circuit of any one of Examples 5-9, wherein a control terminal of the third transistor device and a control terminal of the fourth transistor device are each coupled to the second voltage terminal.

Example 11 includes the integrated circuit of any one of Examples 1-10, further comprising a logic circuit configured to receive an output coupled to a terminal of the second transistor device, wherein the logic circuit is configured to turn off the first transistor device in response to a change in the logic state of the output.

Example 12 includes the integrated circuit of any one of Examples 1-11, wherein the second transistor device is a p-channel device.

Example 13 is a voltage regulator that includes an input voltage rail, a bootstrapped voltage rail, and a saturation sensing circuit. The saturation sensing circuit includes a comparator block coupled between the bootstrapped voltage rail and the input voltage rail and having an output, and a field effect transistor (FET) having a gate coupled to the output of the comparator block and a current terminal coupled to the bootstrapped voltage rail. The comparator block is configured to turn off the FET responsive to a high-side switching element entering a saturation operating mode.

Example 14 includes the voltage regulator of Example 13, wherein, in operation, the bootstrapped voltage rail has a higher voltage than the input voltage rail.

Example 15 includes the voltage regulator of Example 13 or 14, further comprising: the high-side switching element, the high-side switching element coupled between the input voltage rail and a lower voltage terminal; and a capacitor coupled between the bootstrapped voltage rail and the lower voltage terminal.

Example 16 includes the voltage regulator of any one of Examples 13-15, wherein the FET is a first FET and the comparator block comprises a second FET and a third FET.

Example 17 includes the voltage regulator of Example 16, wherein the second FET and the third FET are n-channel devices.

Example 18 includes the voltage regulator of Example 16 or 17, wherein the comparator block comprises a resistor coupled between a drain terminal of the second FET and the bootstrapped voltage rail.

Example 19 includes the voltage regulator of Example 18, wherein the drain terminal of the second FET is coupled to the gate of the first FET.

Example 20 includes the voltage regulator of Example 18 or 19, wherein a drain terminal of the third FET is coupled to the input voltage rail, and a source terminal of the third FET is coupled to a source terminal of the second FET.

Example 21 includes the voltage regulator of any one of Examples 16-20, wherein a gate of the second FET and a gate of the third FET are each coupled to the bootstrapped voltage rail.

Example 22 includes the voltage regulator of any one of Examples 13-21, wherein the FET is a p-channel device.

Example 23 is an integrated circuit comprising the voltage regulator of any one of Examples 13-22.

Example 24 is an integrated circuit that includes a first field effect transistor (FET) device coupled between an input voltage rail and a first voltage terminal, a second FET device having a drain terminal, a source terminal, and a gate terminal with the gate terminal coupled to a second voltage terminal, a third FET device having a drain terminal coupled to the input voltage rail, a source terminal coupled to the source terminal of the second FET device, and a gate terminal coupled to the second voltage terminal, and a fourth FET device having a gate terminal coupled to the drain terminal of the second FET device and having a source terminal coupled to the second voltage terminal.

Example 25 includes the integrated circuit of Example 24, wherein, in operation, the first voltage terminal has a lower voltage than the input voltage rail, and the second voltage terminal has a higher voltage than the input voltage rail.

Example 26 includes the integrated circuit of Example 24 or 25, further comprising: a capacitor coupled between the first voltage terminal and the second voltage terminal; and a resistor coupled between the drain terminal of the second FET device and the second voltage terminal.

Example 27 includes the integrated circuit of any one of Examples 24-26, wherein the second FET device and the third FET device are n-channel devices, and the fourth FET device is a p-channel device.

Example 28 is a saturation detection circuit that includes a first field effect transistor (FET) device having a drain terminal, a source terminal, and a gate terminal with the gate terminal coupled to a voltage terminal, a second FET device having a drain terminal coupled to an input voltage rail, a source terminal coupled to the source terminal of the first FET device, and a gate terminal coupled to the voltage terminal, and a third FET device having a gate terminal coupled to the drain terminal of the first FET device and having a source terminal coupled to the voltage terminal.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device, or a semiconductor component. Furthermore, a voltage rail or more simply a “rail,” may also be referred to as a voltage terminal and may generally mean a common node or set of coupled nodes in a circuit at the same potential.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, such as by an end user and/or a third party.

While the use of particular transistors is described herein, other transistors (or equivalent devices) may be used instead. For example, a p-channel field effect transistor (PFET) may be used in place of an n-channel field effect transistor (NFET) with little or no changes to the circuit. Furthermore, other types of transistors may be used (such as bipolar junction transistors (BJTs)). Furthermore, the devices may be implemented in/over a silicon substrate (Si), a silicon carbide substrate (SiC), a gallium nitride substrate (GaN) or a gallium arsenide substrate (GaAs). Moreover, reference to transistor features such as gate, source, or drain is not intended to exclude any suitable transistor technologies. For instance, features such as source, drain, and gate are typically used to refer to a FET, while emitter, collector, and base are typically used to refer to a BJT. Such features may be used interchangeably herein. For instance, reference to the gate of a transistor may refer to either the gate of a FET or the base of a BJT, and vice-versa. In some examples, a control terminal may refer to either the gate of a FET or the base of a BJT. Any other suitable transistor technologies can be used. Any such transistors can be used as a switch, with the gate or base or other comparable feature acting as a switch select input that can be driven to connect the source and drain (or the emitter and collector, as the case may be).

References herein to a field effect transistor (FET) being “ON” (or a switch being closed) means that the conduction channel of the FET is present, and drain current may flow through the FET. References herein to a FET being “OFF” (or a switch being open) means that the conduction channel is not present, and drain current does not flow through the FET. A FET that is OFF, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter.

Modifications are possible in the described examples, and other examples are possible within the scope of the claims.

What is claimed is:

1. An integrated circuit, comprising:
a first transistor device coupled between an input voltage terminal and a first voltage terminal;
a comparator circuit coupled between a second voltage terminal and the input voltage terminal, the comparator circuit having a comparator circuit output; and
a second transistor device coupled to the second voltage terminal and having a control terminal coupled to the comparator circuit output, wherein the second transistor device is configured to turn off responsive to the first transistor device entering a saturation operating mode.

2. The integrated circuit of claim 1, wherein, in operation, the first voltage terminal has a lower voltage than the input voltage terminal and the second voltage terminal has a higher voltage than the input voltage terminal.

3. The integrated circuit of claim 1, wherein the comparator circuit further comprises a third transistor device and a fourth transistor device.

4. The integrated circuit of claim 3, wherein the comparator circuit further comprises a resistor coupled between a terminal of the third transistor device and the second voltage terminal.

5. The integrated circuit of claim 4, wherein the terminal of the third transistor device is coupled to the control terminal of the second transistor device.

6. The integrated circuit of claim 3, wherein the fourth transistor device is coupled between the input voltage terminal and the third transistor device.

7. The integrated circuit of claim 3, wherein a control terminal of the third transistor device and a control terminal of the fourth transistor device are each coupled to the second voltage terminal.

8. The integrated circuit of claim 1, further comprising a logic circuit configured to receive an output coupled to a terminal of the second transistor device, wherein the logic circuit is configured to turn off the first transistor device in response to a change in a logic state of the output.

9. A voltage regulator, comprising:
an input voltage rail;
a bootstrapped voltage rail; and
a saturation sensing circuit comprising
a comparator block coupled between the bootstrapped voltage rail and the input voltage rail, the comparator block having an output, and
a field effect transistor (FET) having a gate coupled to the output of the comparator block, and a current terminal coupled to the bootstrapped voltage rail,
wherein the comparator block is configured to turn off the FET responsive to a high-side switching element entering a saturation operating mode.

10. The voltage regulator of claim 9, wherein in operation, the bootstrapped voltage rail has a higher voltage than the input voltage rail.

11. The voltage regulator of claim 9, further comprising:
the high-side switching element, the high-side switching element coupled between the input voltage rail and a lower voltage terminal; and
a capacitor coupled between the bootstrapped voltage rail and the lower voltage terminal.

12. The voltage regulator of claim 9, wherein the FET is a first FET and the comparator block comprises a second FET and a third FET.

13. The voltage regulator of claim 12, wherein the comparator block comprises a resistor coupled between a drain terminal of the second FET and the bootstrapped voltage rail.

14. The voltage regulator of claim 13, wherein the drain terminal of the second FET is coupled to the gate of the first FET.

15. The voltage regulator of claim 12, wherein a drain terminal of the third FET is coupled to the input voltage rail, and a source terminal of the third FET is coupled to a source terminal of the second FET.

16. The voltage regulator of claim 12, wherein a gate of the second FET and a gate of the third FET are each coupled to the bootstrapped voltage rail.

17. An integrated circuit, comprising:
a first field effect transistor (FET) device coupled between an input voltage rail and a first voltage terminal;
a second FET device having a drain terminal, a source terminal, and a gate terminal, the gate terminal coupled to a second voltage terminal;
a third FET device having a drain terminal coupled to the input voltage rail, a source terminal coupled to the source terminal of the second FET device, and a gate terminal coupled to the second voltage terminal; and
a fourth FET device having a gate terminal coupled to the drain terminal of the second FET device and having a source terminal coupled to the second voltage terminal.

18. The integrated circuit of claim 17, wherein, in operation, the first voltage terminal has a lower voltage than the input voltage rail, and the second voltage terminal has a higher voltage than the input voltage rail.

19. The integrated circuit of claim 17, further comprising: a capacitor coupled between the first voltage terminal and the second voltage terminal; and a resistor coupled between the drain terminal of the second FET device and the second voltage terminal.

20. The integrated circuit of claim 17, wherein the second FET device and the third FET device are n-channel devices, and the fourth FET device is a p-channel device.
